(19) United States
(12) Patent Application Publication
(10) Pub. No.: US 2025/0341751 A1
(43) Pub. Date: Nov. 6, 2025

(54) METHOD OF CONTROLLING TRANSMISSION RATE OF GLASS IN VEHICLE, SYSTEM FOR IMPLEMENTING THE SAME, AND VEHICLE

(71) Applicant: TOYOTA JIDOSHA KABUSHIKI KAISHA, Aichi-ken (JP)

(72) Inventor: Ryo IGARASHI, Chofu-shi (JP)

(21) Appl. No.: 18/651,695

(22) Filed: May 1, 2024

(51) Int. Cl. G02F 1/163; B60J 3/00; B60J 3/04

(52) U.S. Cl. CPC G02F 1/163; B60J 3/007; B60J 3/04

(57) ABSTRACT

A vehicle includes a first photochromic glass. The vehicle further includes a first sensor configured to detect a condition inside an interior of the vehicle. The vehicle further includes a processor connected to the first photochromic glass and the first sensor. The processor is configured to determine whether to adjust a transmission rate of the first photochromic glass based on at least data from the first sensor and additional data, wherein the additional data relates to at least one of a condition inside the interior of the vehicle, other than the first condition, or information related to the first photochromic glass. The processor is further configured to transmit a signal to the first photochromic glass for changing the transmission rate of the first photochromic glass in response to a determination to change the transmission rate of the first photochromic glass.

### BACKGROUND

A vehicle exposed to high intensity sunlight experiences an increase in internal temperature due to the sunlight propagating through one or more windows of the vehicle. In some instances where a vehicle is parked, prolonged exposure to sunlight propagating through the windows of the vehicle increases the temperature of the vehicle to an uncomfortable degree. In some instances where a vehicle is in motion sunlight propagating through a side window of a vehicle produces glare that is potentially distracting to a driver.

Some approaches to adjusting sunlight entering the vehicle include an occupant of the vehicle actively adjusting a transmission rate of the windows of the vehicle. In some instances, this active involvement by the occupant includes operating an internal system of the vehicle or operating a device connectable to the vehicle. Some approaches to adjusting light entering a vehicle include adjusting a transmission rate of glass based on an intensity of an external light source incident on the vehicle.

### SUMMARY

An aspect of this description relates to a vehicle. The vehicle includes a first photochromic glass. The vehicle further includes a first sensor configured to detect a first condition inside an interior of the vehicle. The vehicle further includes a processor connected to the first photochromic glass and the first sensor. The processor is configured to determine whether to adjust a transmission rate of the first photochromic glass based on data from at least the first sensor and additional data, wherein the additional data relates to at least one of a condition inside the interior of the vehicle, other than the first condition, or information related to the first photochromic glass. The processor is further configured to transmit a signal to the first photochromic glass for changing the transmission rate of the first photochromic glass in response to a determination to change the transmission rate of the first photochromic glass.

An aspect of this description relates to a vehicle. The vehicle includes a first photochromic glass. The vehicle further includes a sensor configured to detect an amount of light inside a cabin of the vehicle. The vehicle further includes a processor connected to the first photochromic glass and the sensor. The processor is configured to determine an amount of light inside the cabin of the vehicle. The processor is further configured to determine whether to adjust a transmission rate of the first photochromic glass based on the amount of light and at least one additional condition inside the cabin of the vehicle. The processor is further configured to transmit a signal to the first photochromic glass for changing the transmission rate of the first photochromic glass in response to a determination to change the transmission rate of the first photochromic glass.

An aspect of this description relates to a method. The method includes determining a condition of a vehicle interior based on sensor data from at least two different sensors. The method further includes determining whether to adjust a transmission rate of the first photochromic glass based on the sensor data. The method further includes transmitting a signal to a first photochromic glass for changing the transmission rate of the first photochromic glass in response to a determination to change the transmission rate of the first photochromic glass.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of a method of controlling a transmission rate of glass in a vehicle, in accordance with some embodiments.

FIG. 2 is a perspective view of a vehicle, in accordance with some embodiments.

FIG. 3 is a block diagram of a system for controlling a transmission rate of glass in a vehicle, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Photochromic glass is capable of changing between nearly transparent to nearly entirely opaque based on a voltage applied to the photochromic glass. Molecules in the photochromic glass change structure based on the applied voltage to the glass. Most photochromic glasses exhibit a noticeable change in transmission rate in response to a small voltage, e.g., as small as 1 volt (V). Due to the ability to significantly change transmission rate in response to a small voltage, transmission rates of photochromic glass in vehicle windows are able to be adjusted with minimal risk to draining a power source of the vehicle, such as a vehicle battery.

Vehicles exposed to sunlight, whether parked or in motion, often experience an increase in temperature due to the sunlight passing through windows of the vehicle to an interior of the vehicle. Changing the transmission rate of one or more windows to reduce an amount of light entering the vehicle helps to moderate the temperature increase in the vehicle. Using photochromic glass within the vehicle to change the transmission rate of the windows of the vehicle helps to control the temperature increase within the vehicle while utilizing small amounts of power. Utilizing small amounts of power helps to reduce the risk of a vehicle battery being drained and prolongs a travel distance for an electric vehicle or reduces power consumption for a hybrid vehicle or gasoline powered vehicle.

Further, predicting an increase in vehicle temperature based on a location of the vehicle or a projected weather forecast further enhances an ability to moderate temperature increases within the vehicle. By utilizing a location of a vehicle, a determination is able to be made regarding whether the vehicle is parked in a location expected to be shaded by some fixed structure, such as a building. In addition, utilizing a weather forecast allows a determination for whether a day is expected to have sunshine, clouds or rain. Consideration of location of the vehicle or the weather forecast helps to avoid power consumption during time periods where a significant temperature increase is not expected. Further, consideration of location of the vehicle or the weather forecast further helps to anticipate a time period where a vehicle is expected to be exposed to sunlight and allows changing of a transmission rate of the windows of the vehicle prior to or shortly after the vehicle is exposed to the sunlight instead of waiting until a temperature of the vehicle has already begun to increase. As a result, an overall increase in vehicle temperature is reduced by considering the location of the vehicle or the weather forecast.

Still further, selectively changing the transmission rate for different windows in the vehicle helps to control vehicle temperature while also conserving power consumption. In a situation where a sunlight is coming through windows on a passenger side of the vehicle, reducing the transmission rate of only the passenger side windows helps to control a temperature increase of the vehicle while also avoid the power consumption associated with reducing the transmission rate of other windows, such as a rear window or a driver side window. Additionally, consideration of an operational state of the vehicle for transmission rate adjustments helps to reduce a risk of interfering with a driver's operation of the vehicle. For example, during driving of the vehicle, the windshield is prohibited from decreasing in transmission. Similarly, a transmission rate of a rear window is also prohibited from decreasing below a certain threshold, in some instances.

In addition, a vehicle parked during nighttime has a risk of being vandalized in order to access valuable items in the interior of the vehicle. Reducing a transmission rate of windows of the vehicle during nighttime helps to obscure whether valuable items are present in the interior of the vehicle. As a result, a risk of vandalism of the vehicle to access valuable items is reduced due to the inability to see the valuable items from an exterior of the vehicle.

This description includes a method and a system for adjusting a transmission rate of one or more windows of a vehicle based on information received by the vehicle. This method and system help to control a temperature of the interior of the vehicle; and to reduce a risk of vandalism of the vehicle in comparison with other approaches.

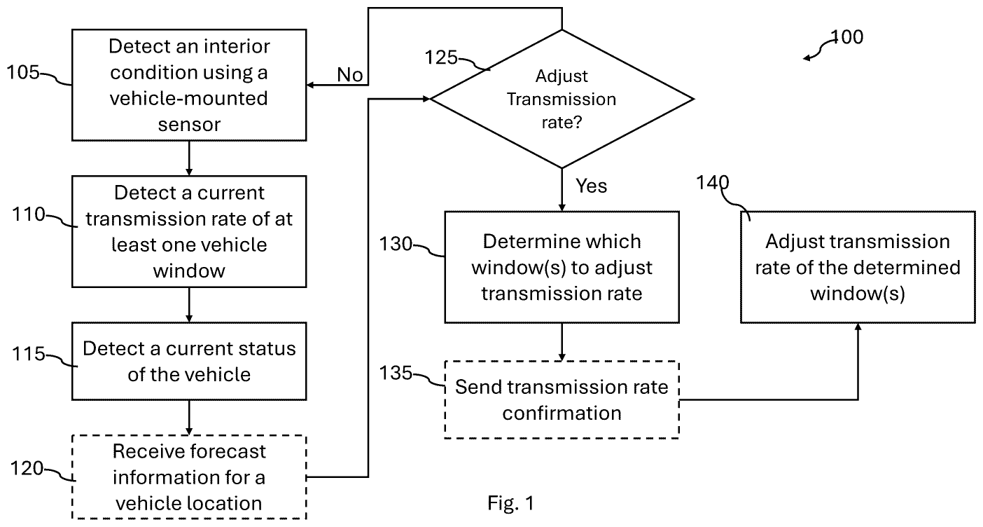

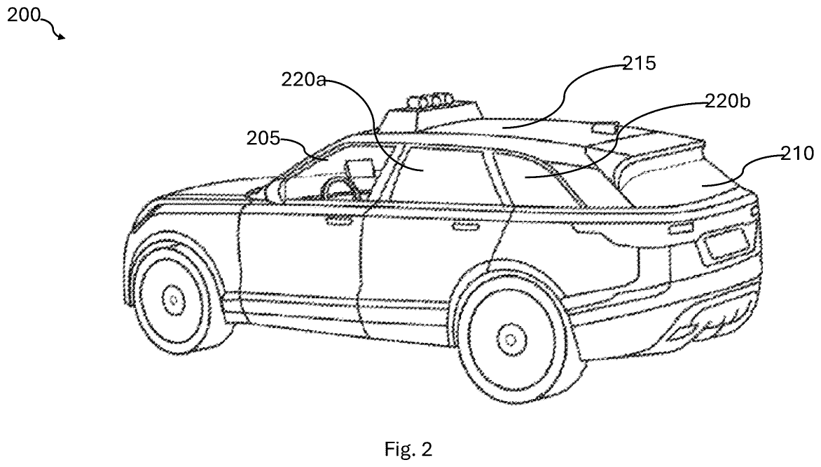

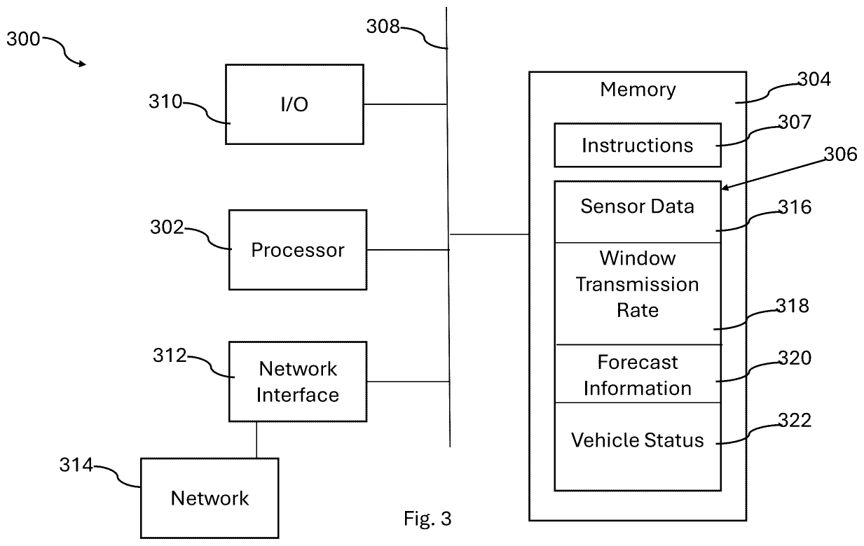

FIG. 1 is a flowchart of a method 100 of controlling a transmission rate of glass in a vehicle in accordance with some embodiments. The method 100 is usable to help regulate a temperature of an interior of a vehicle or reduce a risk of vandalism of the vehicle. In some embodiments, the method 100 is implemented using a system 300 (FIG. 3). In some embodiments, the method 100 is implemented using a system other than the system 300 (FIG. 3). In some embodiments, the method 100 is implemented in a vehicle 200 (FIG. 2). In some embodiments, the method 100 is implemented in a vehicle other than the vehicle 200 (FIG. 2).

In operation 105, an interior condition of a vehicle is detected using a vehicle-mounted sensor. In some embodiments, the interior condition includes a light intensity inside the vehicle interior. In some embodiments, the interior condition includes a temperature of the vehicle interior. In some embodiments, the vehicle-mounted sensor includes a sensor configured to measure a temperature of the vehicle interior, such as a thermometer. In some embodiments, the vehicle-mounted sensor includes a sensor configured to measure the intensity of the light in the vehicle interior, such as a photodiode or a photoresistor. In some embodiments, multiple conditions of the vehicle interior are detected. In some embodiments, a single condition of the vehicle interior is detected. In some embodiments, detecting the interior condition of the vehicle includes detecting an angle of sunlight entering the vehicle interior. In some embodiments, as the angle of the sunlight entering the vehicle approaches 90-degrees, an intensity of the sunlight and an amount of heat associated with the sunlight entering the vehicle increases. Thus, in some embodiments, the change in transmission rate is determined based on a detected angle of the sunlight entering the vehicle. In some embodiments, a magnitude of the transmission rate adjustment is based on the detected angle of the sunlight entering the vehicle. That is, the closer the angle of the sunlight entering the vehicle is to 90-degrees a magnitude of the transmission rate adjustment increases.

In operation 110, a current transmission rate of at least one vehicle window is detected. In some embodiments, a default transmission rate, i.e., a transmission rate without an applied voltage, of one or more vehicle windows is a lowest transmission rate. In some embodiments, the default transmission rate of one or more vehicle windows is a highest transmission rate. In some embodiments, a lowest transmission rate is at or near 0% transmission of incident light. In some embodiments, the lowest transmission rate is 10% transmission of incident light or lower. In some embodiments, a highest transmission rate ranges from about 75% to about 85% transmission of incident light. In some embodiments, the current transmission rate of the at least one vehicle window is determined based on a default transmission rate of the at least one vehicle window and a voltage applied to the at least one vehicle window. In some embodiments, the current transmission rate of the at least one vehicle window is determined based on a sensor in an interior of the vehicle positioned to receive light passing through the at least one vehicle window. In some embodiments, the current transmission rate is determined for each window within the vehicle. In some embodiments, the current transmission rate is determined based on information related to which window(s) within the vehicle are to experience an adjustment in transmission rate. For example, in some embodiments where sunlight is entering the vehicle interior from a passenger side window, the current transmission rate is determined for only passenger side window(s). Determining the current transmission rate for each of the vehicle windows provides a more comprehensive review of the vehicle condition. Limiting the determination of the current transmission rate to only the windows to experience a transmission adjustment reduces processing time and processing power consumption.

In operation 115, a current status of the vehicle is determined. The current status of the vehicle relates to whether the vehicle is being driven, parked or idling. In some embodiments, the vehicle is determined to be in a driving status in response to a transmission of the vehicle being in a position other than park. In some embodiments, the vehicle is determined to be in the driving status in response to the transmission of the vehicle being in park and a time period less than a first threshold having elapsed since the transmission was shifted into the park position. In some embodiments, the vehicle is determined to be in the idling position in response to the transmission being in park and a time period equal to or greater than the first threshold but less than a second threshold having elapsed. In some embodiments, the vehicle is determined to be parked in response to an ignition of the vehicle being OFF. In some embodiments, the vehicle is determined to be parked in response to the transmission being in park and a time period equal to or longer than the second threshold having elapsed. Determining the current status of the vehicle is usable to determine whether transmission rate adjustment is prohibited or restricted for one or more of the windows of the vehicle. A prohibited adjustment to the transmission rate means that no change to the transmission rate of the window is permitted. A restricted adjustment to the transmission rate of the window means that a transmission rate of the window is adjustable, but only to a predetermined extent. For example, a minimum transmission rate of a window for a moving vehicle is dictated by a local government. In some embodiments, when the vehicle is in a driving or idling status, the windshield is prohibited from having a lowered transmission rate to reduce the risk of impacting operation of the vehicle by a driver. In some embodiments, when the vehicle is in the driving status a transmission rate of a rear window of the vehicle is restricted. In some embodiments, when the vehicle is in the idling status a transmission rate of the rear window of a vehicle is not restricted. In some embodiments, when the vehicle is in the parked status no windows of the vehicle have a transmission rate adjustment prohibition or restriction.

In operation 120, forecast information is received for a location of the vehicle. In some embodiments, the forecast information includes weather forecast information. In some embodiments, the forecast information includes sun position information, such as sunrise time or sunset time. In some embodiments, the forecast information is received using a transceiver mounted in the vehicle. In some embodiments, the forecast information is received from a connection to a mobile device, such as a mobile phone. The forecast information is obtained for a location of the vehicle to increase accuracy of the forecast information. In some embodiments, a global position system (GPS) within the vehicle is used to determine the vehicle location. In some embodiments, a GPS system of a mobile device connected to the vehicle is used to determine the vehicle location. Using the forecast information a determination is able to be made regarding whether the vehicle is likely to experience sunlight on windows of the vehicle, when the sunlight is likely to contact the vehicle, and on which windows of the vehicle the sunlight is light to be incident.

Use of forecast information facilitates anticipation of a change in the temperature of the vehicle interior. For example, in some embodiments where the vehicle is currently in a rainy environment but sunshine is forecast for a later time, adjusting the transmission rate is able to be delayed until a time when the sunshine is expected based on the forecast information. In some embodiments, the adjustment of the transmission rate is scheduled prior to a time when the sunshine is expected to further reduce a risk of the temperature of the vehicle interior reaching an uncomfortable level. Delaying the change in transmission rate of the vehicle windows helps to reduce power consumption of the vehicle while still helping to control the temperature of the vehicle interior. In another example, in some embodiments, when a time of the sunset at the vehicle location approaches, the vehicle increases the transmission rate of the vehicle windows to reduce power consumption associated with maintaining a low transmission window at a point in time where a risk of increasing the temperature of a vehicle interior to an uncomfortable level is reduced.

The vehicle location data is also usable to determine whether the vehicle is likely to be positioned in a location that is shaded, thus reducing the sunlight incident on the windows of the vehicle. For example, if the vehicle location information indicates that the vehicle is in a parking garage or adjacent to a building, then adjusting the transmission rate of windows of the vehicle is unlikely to impact increases in the temperature of the vehicle interior. In some embodiments, the location of the vehicle is determined based on a combination of a GPS system and a map stored in the vehicle or on a mobile device connected to the vehicle. In some embodiments, a combination of the vehicle location and forecast information is usable to determine whether to adjust the transmission rate of the vehicle windows. For example, in some embodiments, the vehicle is currently in a shady location adjacent to a building but the forecast information indicates that vehicle will be exposed to increased sunlight in the future, the adjustment of the transmission rate of the windows is able to be adjusted based on an expected time that the vehicle is exposed to the increased sunlight.

In some embodiments, the operation 120 is omitted. Omitting the operation 120 reduces processing load on the vehicle to make a determination of whether to adjust a transmission rate of one or more vehicle windows. Including the operation 120 helps to increase precision in controlling the temperature of the vehicle interior.

In operation 125, a determination is made regarding whether to adjust the transmission rate of one of more windows of the vehicle. The determination regarding whether to adjust a transmission rate of one or more windows of the vehicle is based on the detected interior condition of the vehicle. In some embodiments, the determination regarding whether to adjust the transmission rate of one or more windows of the vehicle is also based on at least one of a current transmission rate of the at least one window, a current status of the vehicle, received forecast information, or vehicle location information.

In some embodiments, the determination regarding whether to adjust the transmission rate is based on a combination of detected interior conditions of the vehicle. That is, in some embodiments, input from multiple different sensors is utilized to determine whether to adjust the transmission rate. Table 1 below provides some examples for combination of detected interior conditions and the result of a determination for adjusting the transmission rate. One of ordinary skill in the art would understand that these examples are not limiting and that other combinations of detected interior conditions are within the scope of this description. Further, a combination of detected interior conditions are also usable with the current status of the vehicle, received forecast information, or vehicle location information to determine whether to adjust the transmission rate, in some embodiments.

TABLE 1

| Case | Light | | |
|---|---|---|---|
| No. | Intensity | Temperature | Determination |
| 1 | Strong | High | Reduce transmission rate |
| 2 | Strong | Low | Maintain or increase transmission rate |
| 3 | Weak | High | Maintain or increase transmission rate |
| 4 | Weak | Low | Maintain or increase transmission rate |

In some embodiments, the determination regarding whether to adjust the transmission rate further includes inhibiting rapid changes in transmission rate. For example, when a detected interior condition is near a threshold value, the determination for whether to adjust the transmission rate has an increased chance of alternating rapidly. In order to reduce distraction for the driver and/or to reduce power consumption, in some embodiments, a predetermined time period is set for how often a transmission rate is permitted to be adjusted. In some embodiments, the predetermined time period is different for different windows within the vehicle. In some embodiments, the predetermined time period ranges from 1 minute to 10 minutes. In some embodiments, multiple changes in transmission rates within the predetermined time period are permitted; and the number of instances of changes in the transmission rate within the predetermined time period has a maximum value. In some embodiments, the maximum value is different for different windows within the vehicle. In some embodiments, the maximum value ranges from 1 to 5. In some embodiments, the maximum value is 3. Table 2 below provides some examples for a combination of a detected interior condition with the number of changes within a predetermine time period and a corresponding result of a determination for adjusting the transmission rate. One of ordinary skill in the art would understand that these examples are not limiting and that other combinations of detected interior conditions are within the scope of this description. Further, a combination of detected interior conditions are also usable with the current status of the vehicle, received forecast information, or vehicle location information to determine whether to adjust the transmission rate as well as the number of changes in transmission rate within the predetermined time period, in some embodiments.

TABLE 2

| | | #Changes within | |
|---|---|---|---|
| | | 10 minutes | |
| Case | Light | (threshold | |
| No | Intensity | is 3 changes) | Determination |
| 1 | Strong | Less than 3 | Decrease transmission rate |
| 2 | Strong | 3 or more | Maintain current transmission rate |
| 3 | Weak | Less than 3 | Maintain or increase transmission |
| | | | rate |
| 4 | Weak | 3 or more | Maintain current transmission rate |

In some embodiments, the determination regarding whether to adjust the transmission rate further includes determining a magnitude of an adjustment of the transmission rate. Several factors are discussed above with respect to a risk for increasing the temperature of the vehicle interior. As a risk of increasing the temperature of the vehicle interior increases the magnitude of the adjustment of the transmission rate increases, in some embodiments.

In response to a determination to adjust the transmission rate, i.e., “Yes” in method 100, the method 100 proceeds to operation 130. In response to a determination not to adjust the transmission rate, i.e., “No” in method 100, the method 100 returns to operation 105.

In operation 130, a determination is made regarding which window(s) to adjust the transmission rate. Determining for which window(s) to adjust the transmission rate is based on a current status of the vehicle. The operation 130 prohibits or restricts changes in a transmission rate of certain windows, e.g., the windshield, based on the current status of the vehicle, as discussed above. In some embodiments, determining for which window(s) to adjust the transmission rate is based on a direction in which the sunlight is entering the vehicle. In some embodiments, determining for which window(s) to adjust the transmission rate is based on vehicle location information. In some embodiments, determining for which window(s) to adjust the transmission rate is based on a detected interior condition for the vehicle. That is, as the temperature increases, more window(s) transmission rates are adjusted in order to help moderate temperature increases in the vehicle interior, in some embodiments. In some embodiments, determining for which window(s) to adjust the transmission rate is based on forecast information, e.g., indicating a direction from which sunlight is expected to enter the vehicle. In some embodiments, a magnitude of transmission rate adjustment for a first window of the vehicle is different from a magnitude of transmission rate adjustment for a second window of the vehicle.

In operation 135, a transmission rate adjustment confirmation is transmitted. In some embodiments, the transmission rate adjustment confirmation is transmitted wirelessly. In some embodiments, the transmission rate adjustment confirmation is transmitted via a wired connection. In some embodiments, the transmission rate adjustment confirmation is displayed on a console of the vehicle. In some embodiments, the transmission rate adjustment confirmation is transmitted to a mobile device accessible by a user. In some embodiments, the transmission rate adjustment confirmation includes an alert to be automatically displayed on the console of the vehicle, the mobile device accessible by the user, or on another suitable device accessible by the user. In some embodiments, the alert is an audio alert or a visual alert.

In some embodiments, the transmission rate adjustment confirmation includes information indicating which window(s) will have an adjusted transmission rate. In some embodiments, the transmission rate adjustment confirmation includes information indicating a magnitude of the adjustment for each of the window(s) to be adjusted. In some embodiments, the method 100 does not proceed beyond operation 135 until a positive action, e.g., an acknowledgement from the user, is received which approves the transmission rate adjustment. In some embodiments, the method 100 proceeds beyond operation 135 following a predetermined time lapse following sending of the transmission rate adjustment confirmation unless a positive action, e.g., a decline from the user, is received which rejects the transmission rate adjustment.

In some embodiments, the operation 135 is omitted. In some embodiments, the operation 135 is omitted based on a detected current vehicle status. For example, in some embodiments, the operation 135 is omitted while the vehicle is in a parked status. In some embodiments, the operation 135 is maintained while the vehicle is detected to be in a driving or idling status. Omitting the operation 135 reduces a processing load on the vehicle and helps to speed up the transmission rate adjustment to better moderate the temperature in the vehicle interior. Maintaining the operation 135 helps to avoid distracting the driver during operation of the vehicle with an unexpected transmission rate adjustment of a window visible by the driver.

In operation 140, the transmission rate of the window(s) identified in the operation 130 are adjusted. The transmission rate of the window(s) identified in the operation 130 are adjusted by a magnitude determined in the operation 130. The transmission rate is adjusted by applying a voltage to the glass to re-orient the molecules in the photochromic glass of the window to make the window(s) more transparent or opaquer. In some embodiments, a controller, e.g., part of the system 300 (FIG. 3), controls the voltage applied to the window to adjust the transmission rate in accordance with the determination in the operation 130. In some embodiments, the voltage applied to the window(s) is from a battery of the vehicle. In some embodiments, the voltage applied to the window(s) is from a power source of the vehicle separate from the vehicle battery.

The above description of the method 100 focuses on reducing sunlight entering the vehicle in order to prevent or reduce an increase in the temperature of the vehicle interior. One of ordinary skill in the art would also recognize that controlling the transmission rate to allow additional sunlight into the vehicle interior is also possible. For example, in some embodiments, when the forecast information indicates that cold temperatures are expected the window(s) of the vehicle are adjusted to be more transparent to allow the interior of the vehicle to have an increased temperature to make the vehicle interior more comfortable for the occupant.

One of ordinary skill in the art would understand that modifications to the method 100 are within the scope of this description. In some embodiments, at least one operation is added to the method 100. For example, in some embodiments, a user is able to set one or more criteria for adjusting the transmission rate of the window(s) of the vehicle. In some embodiments, at least one operation of the method 100 is omitted. For example, in some embodiments, the operation 135 is omitted. In some embodiments, an order of operations of the method 100 is adjusted. For example, in some embodiments, the operation 115 occurs prior to the operation 105.

FIG. 2 is a perspective view of a vehicle 200, in accordance with some embodiments. The vehicle 200 is capable of implementing the method 100 (FIG. 1). In some embodiments, the vehicle 200 is capable of implementing the method 100 (FIG. 1) using a system 300 (FIG. 3) mounted in the vehicle. In some embodiments, the vehicle 200 is able to implement the method 100 (FIG. 1) based on receiving instructions from the system 300 (FIG. 3) remote or separable from the vehicle 200. In some embodiments where the system 300 (FIG. 3) is remote or separable from the vehicle 200, the vehicle 200 is configured to receive instructions for implementing the method 100 (FIG. 1) either wirelessly or via a wired connection.

The vehicle 200 includes numerous windows for which the transmission rate is able to be adjusted. The vehicle 200 further includes a power source for applying the voltage to the windows for adjusting the transmission rate. In some embodiments, the power source is fixed to the vehicle. In some embodiments, the power source is removable from the vehicle.

The vehicle 200 includes a windshield 205. The windshield 205 includes photochromic glass and is capable of adjusting the transmission rate of light through the windshield 205. In some embodiments, the vehicle 200 prevents adjustment of the transmission rate of the windshield 205 based on a status of the vehicle, e.g., adjusting the transmission rate of the windshield 205 is prohibited when the vehicle is in driving status.

The vehicle 200 further includes a rear window 210. The rear window 210 includes photochromic glass and is capable of adjusting the transmission rate of light through the rear window 210. In some embodiments, the vehicle 200 restricts adjusting of the transmission rate of the rear window 210 based on the statue of the vehicle, e.g., the transmission rate of the rear window 210 is restricted from going below a predetermined threshold value.

The vehicle 200 further includes a sunroof 215. The sunroof 215 includes photochromic glass and is capable of adjusting the transmission rate of light through the sunroof 215.

The vehicle 200 further includes a plurality of side windows 220a and 220b, collectively referred to as side windows 220. FIG. 2 includes a front side window of the vehicle 200 in a retracted state to allow a view of the vehicle interior. One of ordinary skill in the art would recognize that the front side window is also part of the vehicle 200. The side windows 220 include photochromic glass capable of adjusting the transmission rate of light through the side windows 220. The view of FIG. 2 includes side windows on only the driver side. One of ordinary skill in the art would recognize that the vehicle 200 includes side windows 220 on a passenger side of the vehicle as well.

The vehicle 200 is capable of independently adjusting the transmission rate of any of the windshield 205, the rear window 210, the sunroof 215, or the side windows 220. The independent adjustment includes both whether to adjust the transmission rate and a magnitude of any such adjustment of the transmission rate. Further, the vehicle 200 is capable of independently adjusting the transmission rate of the side windows 220 of the vehicle. That is, the vehicle 200 is capable of adjusting the transmission rate of the side window 220a while maintaining the transmission rate of the side window 220b. Further, the vehicle 200 is capable of adjusting the transmission rate of the side window 220a at a different magnitude of the transmission rate adjustment for the side window 220b. In addition, the vehicle 200 is capable of independently adjusting the side windows 220 on the driver side relative to the passenger side, and vice versa.

One of ordinary skill in the art would recognize that different sizes of vehicles having different numbers of windows are within the scope of this description. For example, in some embodiments, the vehicle 200 does not include a sunroof 215; or the vehicle 200 includes only two side windows 220 on each side of the vehicle 200.

FIG. 3 is a block view of a system 300 for controlling a transmission rate of window(s) of a vehicle in accordance with one or more embodiments. System 300 includes a hardware processor 302 and a non-transitory, computer readable storage medium 304 encoded with, i.e., storing, the computer program code 306, i.e., a set of executable instructions. Computer readable storage medium 304 is also encoded with instructions 307 for interfacing with manufacturing machines for producing the memory array. The processor 302 is electrically coupled to the computer readable storage medium 304 via a bus 308. The processor 302 is also electrically coupled to an input/output (I/O) interface 310 by bus 308. A network interface 312 is also electrically connected to the processor 302 via bus 308. Network interface 312 is connected to a network 314, so that processor 302 and computer readable storage medium 304 are capable of connecting to external elements via network 314. The processor 302 is configured to execute the computer program code 306 encoded in the computer readable storage medium 304 in order to cause system 300 to be usable for performing a portion or all of the operations as described in method 100 (FIG. 1) or implemented by the vehicle 200 (FIG. 2).

In some embodiments, the processor 302 is a central processing unit (CPU), a multi-processor, a distributed processing system, an application specific integrated circuit (ASIC), and/or a suitable processing unit.

In some embodiments, the computer readable storage medium 304 is an electronic, magnetic, optical, electromagnetic, infrared, and/or a semiconductor system (or apparatus or device). For example, the computer readable storage medium 504 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 504 includes a compact disk-read only memory (CD-ROM), a compact disk-read/write (CD-R/W), and/or a digital video disc (DVD).

In some embodiments, the storage medium 304 stores the computer program code 304 configured to cause system 300 to perform a portion or all of the operations as described in method 100 (FIG. 1) or implemented by the vehicle 200 (FIG. 2). In some embodiments, the storage medium 304 also stores information used for performing a portion or all of the operations as described in method 100 (FIG. 1) or implemented by the vehicle 200 (FIG. 2) as well as information generated during performing a portion or all of the operations as described in method 100 (FIG. 1) or implemented by the vehicle 200 (FIG. 2), such as a sensor data parameter 316, a window transmission rate parameter 318, a forecast information parameter 320, a vehicle status parameter 322, and/or a set of executable instructions to perform the operation of a portion or all of the operations as described in method 100 (FIG. 1) or implemented by the vehicle 200 (FIG. 2).

In some embodiments, the storage medium 304 stores instructions 307 for interfacing with external devices, e.g., mobile devices. The instructions 307 enable processor 302 to generate or receive instructions readable by the external devices during implementation of a portion or all of the operations as described in method 100 (FIG. 1) or implemented by the vehicle 200 (FIG. 2).

System 300 includes I/O interface 310. I/O interface 310 is coupled to external circuitry. In some embodiments, I/O interface 310 includes a keyboard, keypad, mouse, trackball, trackpad, touch screen and/or cursor direction keys for communicating information and commands to processor 302.

System 300 also includes network interface 312 coupled to the processor 302. Network interface 312 allows system 300 to communicate with network 314, to which one or more other computer systems are connected. Network interface 312 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in method 100 (FIG. 1) or implemented by the vehicle 200 (FIG. 2) is implemented in two or more systems 300, and information such as sensor data, window transmission rate, forecast information or vehicle status are exchanged between different systems 300 via network 314.

### Supplemental Note 1

An aspect of this description relates to a vehicle. The vehicle includes a first photochromic glass. The vehicle further includes a first sensor configured to detect a first condition inside an interior of the vehicle. The vehicle further includes a processor connected to the first photochromic glass and the first sensor. The processor is configured to determine whether to adjust a transmission rate of the first photochromic glass based on data from at least the first sensor and additional data, wherein the additional data relates to at least one of a condition inside the interior of the vehicle, other than the first condition, or information related to the first photochromic glass. The processor is further configured to transmit a signal to the first photochromic glass for changing the transmission rate of the first photochromic glass in response to a determination to change the transmission rate of the first photochromic glass.

### Supplemental Note 2

The vehicle according to Supplemental Note 1, wherein the sensor is configured to detect an amount of sunlight entering the interior of the vehicle.

### Supplemental Note 3

The vehicle according to Supplemental Note 1 or Supplemental Note 2, wherein the sensor is configured to detect a temperature of the interior of the vehicle.

### Supplemental Note 4

The vehicle according to any of Supplemental Note 1-3, wherein the processor is configured to determine whether to adjust the transmission rate of the first photochromic glass further based on at least one of vehicle location information, a current status of the vehicle, forecast information, a number of instances of changing in transmission rate within a predetermined period of time, or a detected angle of sunlight entering the interior of the vehicle.

### Supplemental Note 5

The vehicle according to any of Supplemental Note 1-4, further comprising a second photochromic glass separate from the first photochromic glass.

### Supplemental Note 6

The vehicle according to any of Supplemental Note 1-5, wherein the processor is configured to determine whether to adjust a transmission rate of the second photochromic glass based on the data from the sensor, and the determination with respect to the second photochromic glass is independent from the determination with respect to the first photochromic glass.

### Supplemental Note 7

The vehicle according to any of Supplemental Note 1-6, wherein the processor is configured to transmit the signal to the first photochromic glass for adjusting the transmission rate of the first photochromic glass by a first magnitude, and to transmit a second signal to the second photochromic glass for adjusting a transmission rate of the second photochromic glass by a second magnitude different from the first magnitude.

### Supplemental Note 8

The vehicle according to any of Supplemental Note 1-7, wherein the first photochromic glass is one of a windshield, a sunroof, a rear window or a side window.

### Supplemental Note 9

The vehicle according to any of Supplemental Note 1-8, wherein a default transmission rate of the first photochromic glass is a highest transmission rate of the first photochromic glass.

### Supplemental Note 10

The vehicle according to any of Supplemental Note 1-10, wherein the processor is further configured to prohibit or restrict adjusting the transmission rate of the first photochromic glass based on a current status of the vehicle.

### Supplemental Note 11

An aspect of this description relates to a vehicle. The vehicle includes a first photochromic glass. The vehicle further includes a sensor configured to detect an amount of light inside a cabin of the vehicle. The vehicle further includes a processor connected to the first photochromic glass and the sensor. The processor is configured to determine an amount of light inside the cabin of the vehicle. The processor is further configured to determine whether to adjust a transmission rate of the first photochromic glass based on the amount of light and at least one additional condition inside the cabin of the vehicle. The processor is further configured to transmit a signal to the first photochromic glass for changing the transmission rate of the first photochromic glass in response to a determination to change the transmission rate of the first photochromic glass.

### Supplemental Note 12

The vehicle according to Supplemental Note 11, wherein the processor is configured to determine whether an environment outside of the vehicle is nighttime, and to determine to adjust the transmission rate of the first photochromic glass in response to a determination that the environment outside of the vehicle is nighttime.

### Supplemental Note 13

The vehicle according to Supplemental Note 11 or Supplemental Note 12, wherein the processor is configured to determine whether to adjust the transmission rate of the first photochromic glass further based on at least one of vehicle location information, a current status of the vehicle, forecast information, a number of instances of changing in transmission rate within a predetermined period of time, or a detected angle of sunlight entering the interior of the vehicle.

### Supplemental Note 14

The vehicle according to any of Supplemental Note 11-13, further comprising a second photochromic glass separate from the first photochromic glass.

### Supplemental Note 15

The vehicle according to any of Supplemental Note 11-14, wherein the processor is configured to determine whether to adjust a transmission rate of the second photochromic glass based on the data from the sensor, and the determination with respect to the second photochromic glass is independent from the determination with respect to the first photochromic glass.

### Supplemental Note 16

The vehicle according to any of Supplemental Note 11-15, wherein the processor is configured to transmit the signal to the first photochromic glass for adjusting the transmission rate of the first photochromic glass by a first magnitude, and to transmit a second signal to the second photochromic glass for adjusting a transmission rate of the second photochromic glass by a second magnitude different from the first magnitude.

### Supplemental Note 17

The vehicle according to any of Supplemental Note 11-16, wherein the first photochromic glass is one of a windshield, a sunroof, a rear window or a side window.

### Supplemental Note 18

An aspect of this description relates to a method. The method includes determining a condition of a vehicle interior based on sensor data from at least two different sensors. The method further includes determining whether to adjust a transmission rate of the first photochromic glass based on the sensor data. The method further includes transmitting a signal to a first photochromic glass for changing the transmission rate of the first photochromic glass in response to a determination to change the transmission rate of the first photochromic glass.

### Supplemental Note 19

The method according to Supplemental Note 18, wherein transmitting the signal comprises transmitting the signal from outside the vehicle.

### Supplemental Note 20

The method according to Supplemental Note 18, wherein transmitting the signal comprises transmitting the signal from inside the vehicle.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A vehicle comprising:
a first photochromic glass;
a first sensor configured to detect a first condition inside an interior of the vehicle;
a processor connected to the first photochromic glass and the first sensor, wherein the processor is configured to:
determine whether to adjust a transmission rate of the first photochromic glass based on at least the first condition and additional data, wherein the additional data relates to at least one of a condition inside the interior of the vehicle, other than the first condition, or information related to the first photochromic glass; and
transmit a signal to the first photochromic glass for changing the transmission rate of the first photochromic glass in response to a determination to change the transmission rate of the first photochromic glass.

2. The vehicle according to claim 1, wherein the sensor is configured to detect an amount of sunlight entering the interior of the vehicle.

3. The vehicle according to claim 1, wherein the sensor is configured to detect a temperature of the interior of the vehicle.

4. The vehicle according to claim 1, wherein the processor is configured to determine whether to adjust the transmission rate of the first photochromic glass further based on at least one of vehicle location information, a current status of the vehicle, forecast information, a number of instances of changing in transmission rate within a predetermined period of time, or a detected angle of sunlight entering the interior of the vehicle.

5. The vehicle according to claim 1, further comprising a second photochromic glass separate from the first photochromic glass.

6. The vehicle according to claim 5, wherein the processor is configured to determine whether to adjust a transmission rate of the second photochromic glass based on the data from the sensor, and the determination with respect to the second photochromic glass is independent from the determination with respect to the first photochromic glass.

7. The vehicle according to claim 5, wherein the processor is configured to transmit the signal to the first photochromic glass for adjusting the transmission rate of the first photochromic glass by a first magnitude, and to transmit a second signal to the second photochromic glass for adjusting a transmission rate of the second photochromic glass by a second magnitude different from the first magnitude.

8. The vehicle according to claim 1, wherein the first photochromic glass is one of a windshield, a sunroof, a rear window or a side window.

9. The vehicle according to claim 1, wherein a default transmission rate of the first photochromic glass is a highest transmission rate of the first photochromic glass.

10. The vehicle according to claim 1, wherein the processor is further configured to prohibit or restrict adjusting the transmission rate of the first photochromic glass based on a current status of the vehicle.

11. A vehicle comprising:
a first photochromic glass;
a sensor configured to detect an amount of light inside a cabin of the vehicle;
a processor connected to the first photochromic glass and the sensor, wherein the processor is configured to:
determine an amount of light inside the cabin of the vehicle;
determine whether to adjust a transmission rate of the first photochromic glass based on the amount of light and at least one additional condition inside the cabin of the vehicle; and
transmit a signal to the first photochromic glass for changing the transmission rate of the first photochromic glass in response to a determination to change the transmission rate of the first photochromic glass.

12. The vehicle according to claim 11, wherein the processor is configured to determine whether an environment outside of the vehicle is nighttime, and to determine to adjust the transmission rate of the first photochromic glass in response to a determination that the environment outside of the vehicle is nighttime.

13. The vehicle according to claim 11, wherein the processor is configured to determine whether to adjust the transmission rate of the first photochromic glass further based on at least one of vehicle location information, a current status of the vehicle, forecast information, a number of instances of changing in transmission rate within a predetermined period of time, or a detected angle of sunlight entering the interior of the vehicle.

14. The vehicle according to claim 11, further comprising a second photochromic glass separate from the first photochromic glass.

15. The vehicle according to claim 14, wherein the processor is configured to determine whether to adjust a transmission rate of the second photochromic glass based on the data from the sensor, and the determination with respect to the second photochromic glass is independent from the determination with respect to the first photochromic glass.

16. The vehicle according to claim 14, wherein the processor is configured to transmit the signal to the first photochromic glass for adjusting the transmission rate of the first photochromic glass by a first magnitude, and to transmit a second signal to the second photochromic glass for adjusting a transmission rate of the second photochromic glass by a second magnitude different from the first magnitude.

17. The vehicle according to claim 11, wherein the first photochromic glass is one of a windshield, a sunroof, a rear window or a side window.

18. A method comprising:
determining a condition of a vehicle interior based on sensor data from at least two different sensors;
determining whether to adjust a transmission rate of the first photochromic glass based on the sensor data; and
transmitting a signal to a first photochromic glass for changing the transmission rate of the first photochromic glass in response to a determination to change the transmission rate of the first photochromic glass.

19. The method according to claim 18, wherein transmitting the signal comprises transmitting the signal from outside the vehicle.

20. The method according to claim 18, wherein transmitting the signal comprises transmitting the signal from inside the vehicle.
